(19) United States
(12) Patent Application Publication
(10) Pub. No.: US 2025/0005657 A1
(43) Pub. Date: Jan. 2, 2025

(54) AUTOMOTIVE BIDDING SYSTEMS

(71) Applicant: CarSolve, Inc., Brush Prairie, WA (US)

(72) Inventor: Norman Hardy, Brush Prairie, WA (US)

(21) Appl. No.: 18/755,554

(22) Filed: Jun. 26, 2024

Related U.S. Application Data
(60) Provisional application No. 63/510,312, filed on Jun. 26, 2023.

(51) Int. Cl. G06Q 30/08

(52) U.S. Cl. CPC G06Q 30/08

(57) ABSTRACT

An online bidding system for selling and buying used vehicles is described. The bidding system has a seller interface programmed to (i) receive vehicle information from one or more used vehicle sellers and (ii) send the vehicle information to a listing agent. The bidding system also has a business development platform comprising a listing agent interface and a sales manager interface. The listing agent interface is programmed to receive the vehicle information and appraise the used vehicle. The sales manager interface is programmed to manage a non-public live online bidding marketplace with state-licensed dealers. The bidding system also has a buyer interface programmed to allow one or more qualified car dealers to anonymously shop for, and bid on, the used vehicle in the non-public live online bidding marketplace. The seller interface is further programmed to monitor the non-public live online bidding marketplace and display a current bid price.

### FIELD OF THE INVENTION

The field of the invention is automotive bidding systems, in particular, methods, systems, and interfaces that facilitate the selling of vehicles from private car owners to dealers.

### BACKGROUND

The following description includes information that may be useful in understanding the present inventive subject matter. It is not an admission that any of the information provided herein is prior art or relevant to the presently claimed invention, or that any publication specifically or implicitly referenced is prior art. All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Dealers typically do not purchase used cars from remote sellers because the dealers prefer to physically inspect the car in their own repair shop in order to determine an accurate valuation for the vehicle before making an offer. This reduces the risk that a dealer will overpay for a car that has underlying issues. A dealer's used car inventory is therefore often limited to trade-ins from new car sales and lease completions. Unfortunately, the shortage of new cars has dramatically decreased the number of trade-ins from new car sales. Moreover, the increase in used car prices has incentivized the leasee to sell their used cars in the public market rather than turn-in to a dealer upon completion of the lease. As a result, dealers are having a harder and harder time finding used cars, and especially, used cars that are in good condition and have low mileage (e.g., less than 30,000 miles). The dealers' hesitancy to buy used cars online from remote sellers also negatively affects sellers because sellers are not able to reach as many potential buyers. It would be advantageous to provide an online marketplace where dealers can competitively bid on vehicles owned by private parties.

Some dealers purchase used cars from auctions. Unfortunately, auction agents typically only allow certified/licensed dealers to list used vehicles in live auctions because the dealers have special insurance and bond requirements that protect the auction agent from liabilities. That means the public market (e.g., private seller) is not able to sell to certified dealers in live auctions. This is very unfortunate because live auctions can often generate the highest sell price through competitive bidding.

Carmax, Carvana, and Carmigo are other examples of online market places for buying and selling used vehicles. While advantageous in many regards, these systems do not encourage the highest sale price for private car owners because there is no bidding incentive and transaction costs are high.

It would be advantageous to provide a transaction platform that facilitates the sale of used cars from the public market to dealers. It would also be advantageous to provide an automotive bidding system that encourages the highest price for a used vehicle and attracts the highest number of sellers and buyers. It would also be advantageous to provide a marketplace that increases confidence between private sellers and state-licensed dealers.

Thus, there remains a need for improved vehicle trading platforms, automotive bidding systems, used vehicle marketplaces, and their methods of use.

### SUMMARY OF THE INVENTION

The inventive subject matter provides apparatus, systems, and methods in which a bidding system for used vehicles comprises (i) a listing agent that negotiates listing agreements with sellers of used vehicles to offer their vehicles for sale in a live online bidding marketplace; (ii) a sales agent that manages the live online bidding marketplace via a sales manager interface; and (iii) a plurality of certified dealer buyers that shop for, and bid on, the used vehicles in the live online bidding marketplace via a buyer interface. The listing agent interface is programmed to receive seller information and vehicle information from the listing agent. The seller interface is programmed to display current bid price of a live bidding event and an option to lower a target price (e.g., reserve price). The dealer buyer interface is programmed to display a filtered subset of used vehicles for sale in the live online bidding marketplace, including the current bid price, target price, and time until live bid ends.

The listing agent preferably offers professional automotive purchasing services all over the United States. The marketplace allows the sellers to monitor the bidding process and leverage the selling price (e.g., reserve price) in order to get the most value out of the available offers and bids.

The listing agent shares its professional vision of the bidding process and educates the sellers to help them make informed decisions based on a likelihood of getting the top price over the bidding duration. The listing agent is incentivized to obtain the highest bid because the listing agent is paid based on a percentage of the sale. To make this happen, the seller will have an opportunity to change the reserve price to a more reasonable price (i.e., a lower price than the original reserve price) during the live bidding event, based on live results. In other words, the ultimate goal is to show the sellers what the current reasonable price is for their vehicle based on the demand in the live bidding event, and allow them to lower their reserve price to accept a lower bid. At the same time, the marketplace encourages dealers to pay the highest price as soon as possible because the bidding is volatile and unpredictable (e.g., reserve prices can suddenly change). The dealer interface also makes it very easy to track different items in ongoing bidding events so that you can make quick decisions about prices in near real-time as the bidding progresses.

The listing agent also preferably offers valuation services that are reliable and trusted by all the dealers. The listing agent can use standardized and transparent methods for inspecting and evaluating used cars. In such embodiments, the listing agent will inspect the vehicle for damage and any other issues that might affect valuation, and provide photographs, videos, and other documentation of the issues to the dealer via the online marketplace and dealer interface.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a schematic of a bidding system for listing used vehicles for sale to dealers in a live online bidding marketplace.

FIG. 2 is a flow chart of a process for transacting the sale of a used vehicle.

FIGS. 3A-3L are a seller interface for sending vehicle information to a listing agent.

FIGS. 4A-4J are a seller interface for obtaining an appraisal for a used vehicle.

FIGS. 5A-5H are a listing agent interface for receiving and reviewing vehicle information and for listing the vehicle information on an online marketplace.

FIGS. 6A-6N are a sales manager interface for making an offer and for listing the vehicle information in a live online bidding marketplace.

FIGS. 7A-7F are a buyer interface for shopping for, and bidding on, used vehicles in a live online bidding marketplace.

FIGS. 8A-8N are a seller interface for monitoring a live online bidding marketplace of the seller's used vehicle and for accepting, rejecting, or making a counter offer when the current bid is less than a target price.

FIGS. 9A-9M are a seller interface for registering and listing a used vehicle.

FIGS. 10A-10G are a seller interface for reviewing vehicle information and obtaining a valuation.

FIGS. 11A-11T are a seller interface for monitoring a live online bidding event.

FIGS. 12A-12P are a seller interface for monitoring a live online bidding event, making a counter offer, and scheduling an inspection appointment with a winning bidder.

FIGS. 13A-13F are a sales manager interface for initiating and monitoring a bidding event.

FIGS. 14A-14F are a buyer interface for bidding on a vehicle, accepting a counteroffer and scheduling an inspection.

### DETAILED DESCRIPTION OF THE INVENTION

The following discussion provides many example embodiments of the inventive subject matter. The embodiments described herein are not intended to be an exhaustive list or to limit the inventive subject matter to the precise form disclosed. The disclosed embodiments are chosen and described to merely explain the principles of the inventive subject matter and its application and practical use so as to enable others skilled in the art to follow its teachings.

The inventive devices, systems, and methods will be understood, both as to its structure and operation, from the accompanying drawings, taken in conjunction with the accompanying description. Although each embodiment represents a single combination of inventive elements, the inventive subject matter is considered to include all possible combinations of the disclosed elements. As such, it should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise. Thus, if one embodiment comprises elements A, B, and C, and a second embodiment comprises elements B and D, then the inventive subject matter is also considered to include other remaining combinations of A, B, C, or D, even if not explicitly disclosed.

It should be noted that any language directed to a computer should be read to include any suitable combination of computing devices, including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

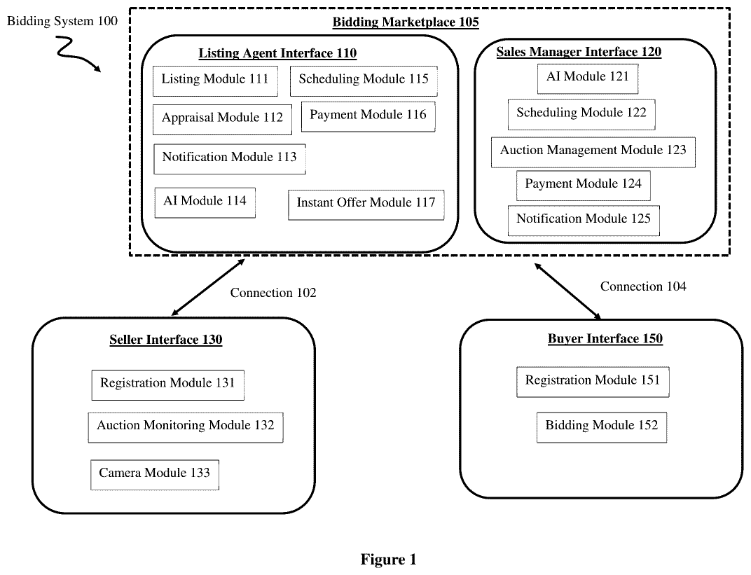

FIG. 1 shows a schematic of an online bidding system 100 for selling and buying used cars. Bidding system 100 is preferably configured to facilitate the transaction of used vehicles from private sellers to certified dealers. Bidding system 100 comprises a business development platform 105. Platform 105 has a listing agent interface 110 and a sales manager interface 120.

Listing agent interface 110 has a listing module 111 programmed to collect and receive vehicle information from one or more sellers interested in selling a used vehicle and send the vehicle information to a listing agent. The listing agent provides consulting services to the seller and helps the seller determine an appropriate sale price. The listing agent verifies and qualify the seller and may also physically inspect the used vehicle being listed for sale.

Listing agent interface 110 has an appraisal module 112 programmed to determine a value range of the used vehicle based on the vehicle information, live daily auction and retail sales data, and/or other third-party valuation databases.

Listing agent interface 110 has a notification module 113 programmed to notify the seller when the used vehicle is listed in the non-public live online bidding marketplace and when a bid meeting the target price is placed. Notification module 113 also notifies the seller when the bidding ends and the target price has not been met and an option to make a counteroffer.

Listing agent interface 110 has an AI module 114 programmed to interact with the seller to gather vehicle information. AI module 114 is preferably conversational and can include a virtual assistant and/or chat bot for gathering seller information and vehicle information. AI module 114 is also preferably programmed to consult with the seller regarding an appropriate sell price and helps to verify and qualify the seller.

Listing agent interface 110 has a scheduling module 115 programmed to schedule a consultation between the seller and the listing agent. During the consultation, the listing agent can help the seller determine an appropriate listing price for the used vehicle. The listing agent can also verify the seller's information and the vehicle information. Scheduling module 115 is also programmed to schedule an inspection of the vehicle with the seller. live online bidding marketplace live online bidding marketplace

Listing agent interface 110 has a payment module 116 programmed to process a listing fee from the seller.

Listing agent interface 110 has an instant offer module 117 programmed to calculate an instant offer estimate for the used vehicle.

Sales manager interface 120 has an AI module 121 programmed to answer questions and educate the seller on the valuation of the used vehicle and the process of listing the used vehicle in a non-public live online bidding marketplace.

Sales manager interface 120 has a scheduling module 122 programmed to facilitate a delivery time between the seller and the buyer.

Sales manager interface 120 has an bidding marketplace module 123 programmed to display a status of the non-public live online bidding marketplace.

Sales manager interface 120 has a payment module 124 programmed to receive payment from a seller upon completion of a successful bid.

Sales manager interface 120 has a notification module 125 programmed to notify the seller when the non-public live bidding begins. Notification module 125 is also programmed to notify the seller of any status changes in the bidding event, such as a new bid or a bid that passes the seller's listing price.

Bidding system 100 also includes a seller interface 130 communicatively coupled with business development platform 105 via connection 102. Connection 102 can be a wired or wireless connection. In preferred embodiments, seller interface 130 is on a device that is located remotely from platform 105.

Seller interface 130 has a registration module 131 programmed to send seller information and vehicle information to listing agent interface 110.

Seller interface 130 has a bidding monitoring module 132 programmed to display information about the non-public live online bidding marketplace, such as a history of bids, the current high bid, time remaining in the bidding event, an option to accept a bid that is below the asking price, and an option to consult with the listing agent or sales manager.

Seller interface 130 has a camera module 133 programmed to capture photographs of the used vehicle. Camera module 133 preferably has tamperproof algorithms and is a proprietary software application that restricts the seller's ability to change the image or metadata prior to sending the images to platform 105.

Bidding system 100 also includes a buyer interface 150 communicatively coupled with business development platform 105 via connection 104. Connection 104 can be a wired or wireless connection. In preferred embodiments, buyer interface 150 is on a device that is located remotely from platform 105.

Buyer interface 150 has a registration module 151 programmed to gather a buyer's information. Registration module 151 is also programmed to verify and qualify the buyer, such as by confirming that the buyer is a state-licensed dealer that is in legal compliance with bond and insurance laws.

Buyer interface 150 has a bidding module 152 programmed to display information about the non-public live online bidding marketplace, such as the current high bid, time remaining in the bidding event, and an option to place a bid. Bidding module 152 is also programmed to send notifications to the buyer when a new vehicle listing goes live and when a bid has been accepted. Bidding module 152 is also preferably programmed to show the buyer any new listings, including the vehicle information, and the time/date that the vehicle will be listed in a non-public live online bidding marketplace.

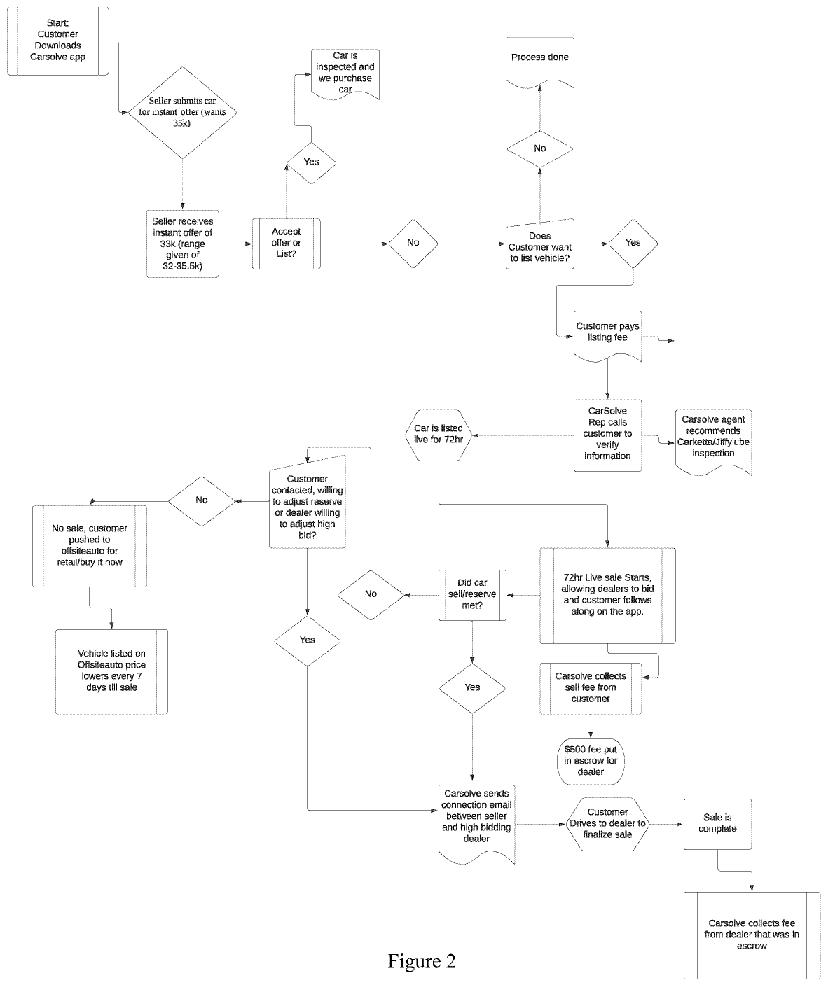

FIG. 2 shows a flow chart of a process for transacting the sale of a used vehicle using bidding system 100. First, a seller enters/opens seller interface 130 and submits vehicle information to receive an initial valuation of the vehicle (e.g., “instant offer”). The instant offer price (or price range) is a price that the owner/provider of business development platform 105 (e.g., CarSolve) is likely willing to pay for the vehicle directly (e.g., not through an auction or bidding event). This price range gives the seller context for determining a listing price for a non-public live online bidding marketplace. However, if the seller prefers to sell the vehicle right away rather than wait for an bidding event, and the seller is willing to accept the instant offer, then the owner of platform 105 will inspect the vehicle and make a final offer to purchase the vehicle. In this case, the seller does not need to pay any listing fee for a non-public live online bidding marketplace.

If the seller prefers to pay a listing fee and wait for a non-public live online bidding marketplace, in the hopes of receiving a higher purchase price than the instant offer, then the seller pays the listing fee, and a listing agent contacts the seller to verify the seller's information and the vehicle information. The listing agent may also recommend that the seller pay an additional fee to have professional photography services and to get an inspection at a third party auto mechanic shop (e.g., Carketta, Jiffy-Lube, etc.). The listing agent also consults with the seller to determine a listing price for the vehicle (e.g., reserve price). The reserve price is the minimum price that the seller is obligated to accept in the non-public live online bidding marketplace.

Once a reserve price is determined, the vehicle is listed in a non-public live online bidding marketplace. The bidding event will take place for a limited period of time (e.g., 72 hours). During that time, buyers can view the vehicle's information and place competing bids using buyer interface 150. However, buyers must first pay a listing fee in escrow in order to participate in the bidding event. The listing price will not be visible to the buyers so as to encourage higher bids. The seller can monitor bids in real-time using seller interface 130.

If the reserve price is not met during the non-public live online bidding marketplace, the seller has an option to either accept the highest bid or to re-list the vehicle in another non-public live online bidding marketplace. The seller also has the option to accept a lower price than the reserve price at any time during the non-public live online bidding marketplace. The seller also has the option to make a counteroffer to the highest bidder.

If the reserve price is met or surpassed once the bidding event has completed, then the seller and buyer are notified by platform 105 that the bidding event was successful. Platform 105 also schedules a time for the seller to deliver the vehicle to the buyer. The buyer then inspects the vehicle to confirm that it matches the vehicle information listed in the non-public live online bidding marketplace. Buyer then plays the seller and title of the vehicle passes from the seller to the buyer. Platform 105 collects the listing fee from the buyer. It is also contemplated that platform 105 could collect a transaction fee or sale fee from the seller, which is different than the listing fee.

If the bidding event ends without meeting the reserve price, the seller can choose to make a counter offer to the highest bidder and the buyer can choose whether to accept or reject the counter offer.

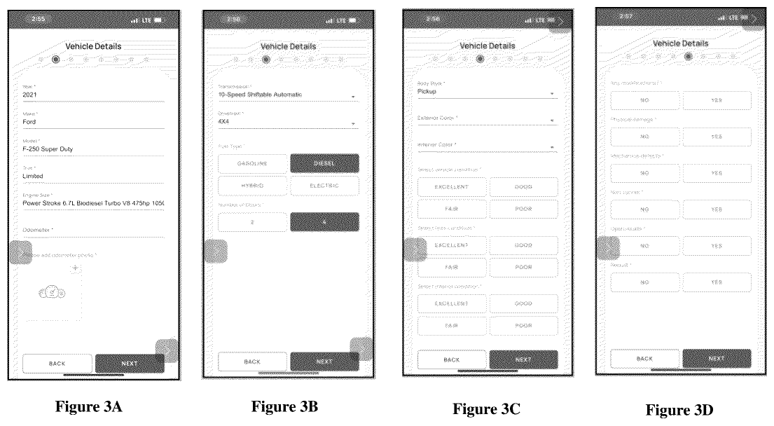

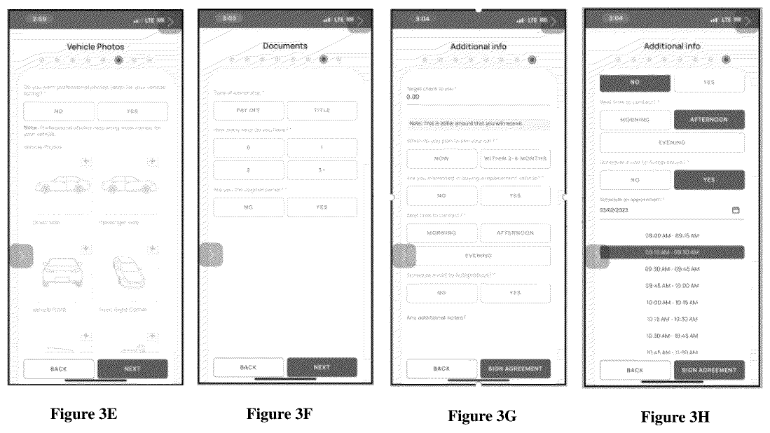

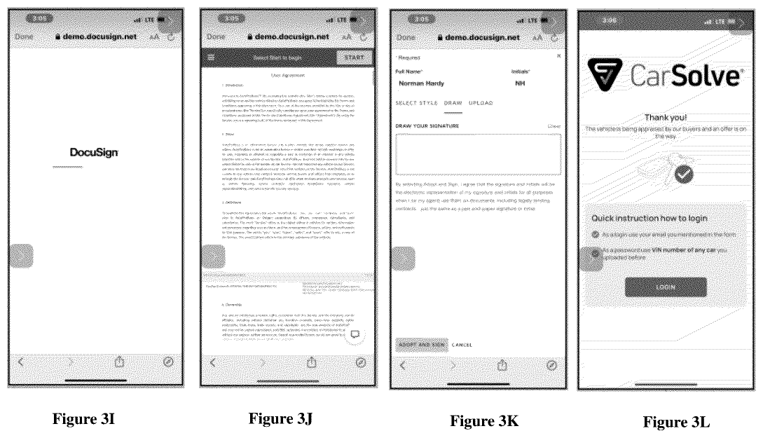

FIGS. 3A-3L show screenshots of seller interface 130 for registering the seller, collecting vehicle information, and executing a listing agreement. In FIG. 3a, the seller's information is collected. In FIGS. 3b-3f, the vehicle information is collected. In FIG. 3g, vehicle financial information and title are collected. In FIG. 3h, transactional information is collected. In FIG. 3i, the seller's availability information is collected. In FIGS. 3j-31, terms and conditions of the listing agreement are provided to the seller for signature.

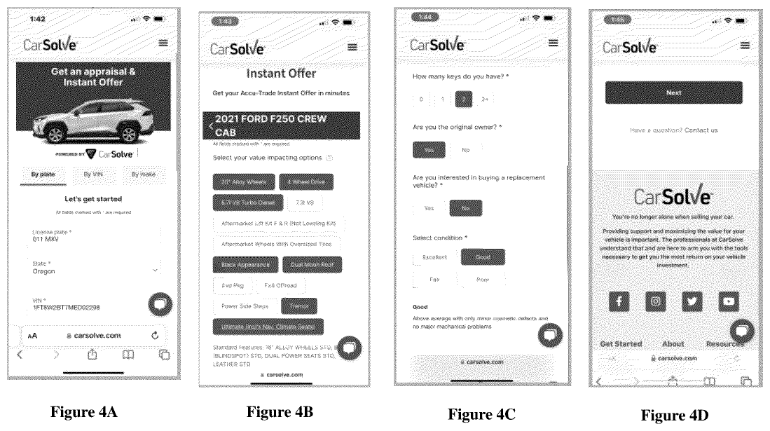

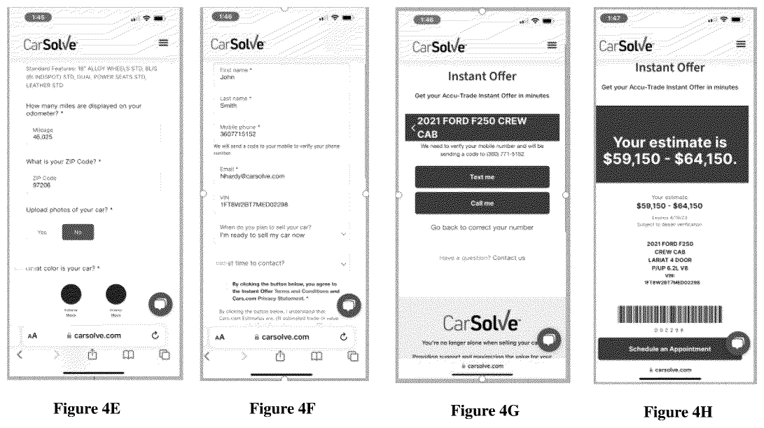

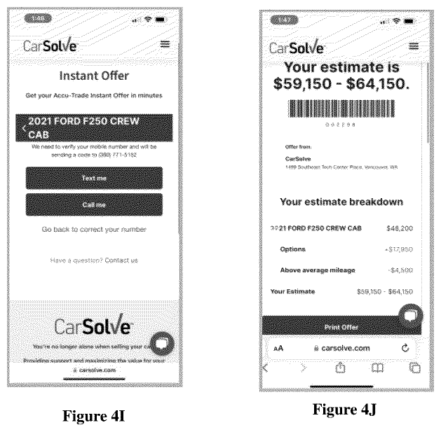

FIGS. 4A-4J show screenshots of seller interface 130 for obtaining an “instant offer” (e.g., an initial valuation and estimate for the vehicle). In FIGS. 4a-4f, the seller's information and vehicle information are collected and/or displayed. The information can be auto-populated if already provided in FIGS. 3a-31. In FIGS. 4g-4i, the instant offer option is explained, and a price range is displayed.

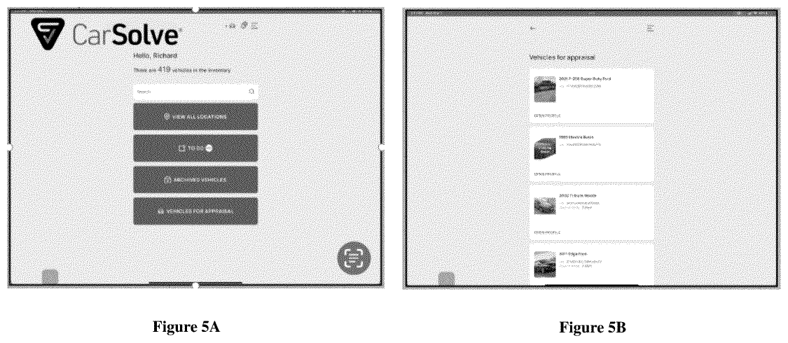

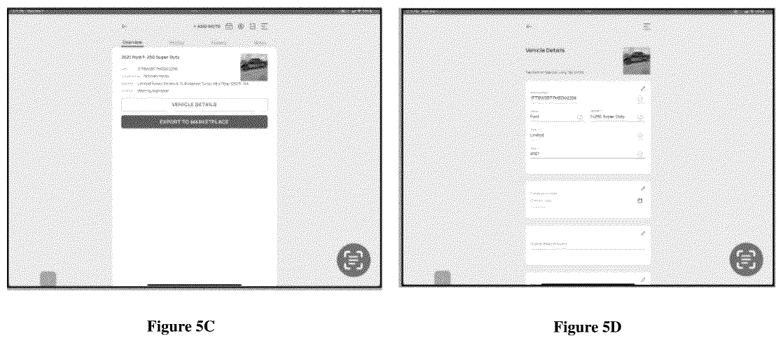

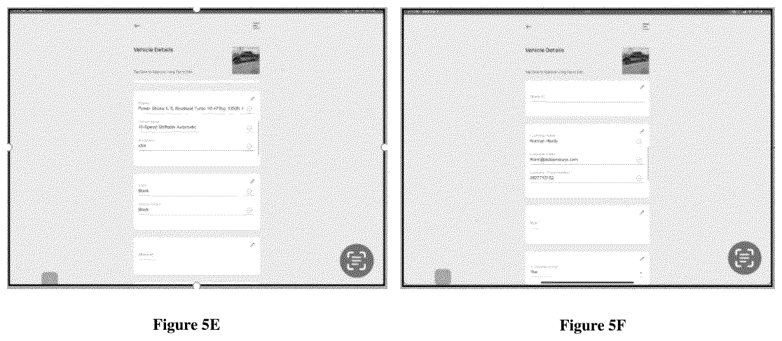

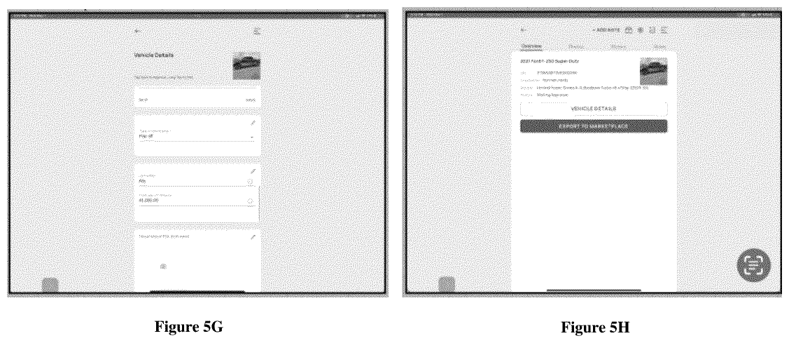

FIGS. 5A-5H show screenshots of listing agent interface 110. In FIG. 5a, the listing agent can see all vehicles currently listed in the inventory of platform 105, as well as all registered sellers and buyers, and all live and completed bidding events. In FIG. 5b, the vehicle inventor is shown with an option to filter the inventory. In FIG. 5c-5g, information for a selected vehicle is shown. In FIG. 5h, the listing agent has the option to export the vehicle to the marketplace to start a non-public live online bidding marketplace.

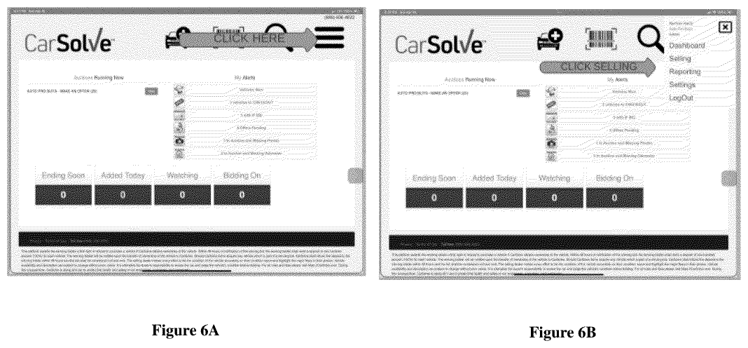

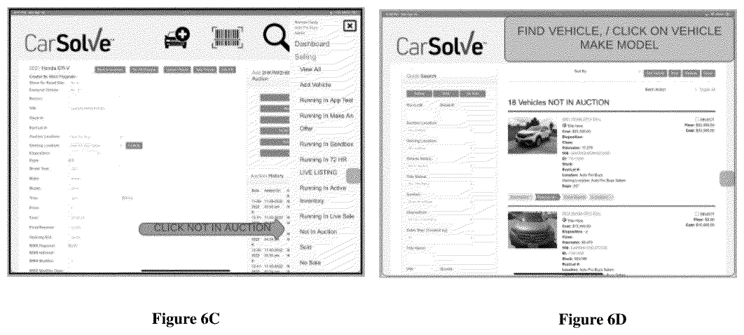

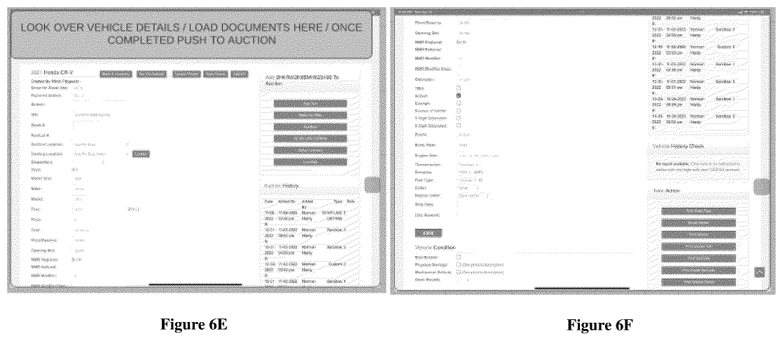

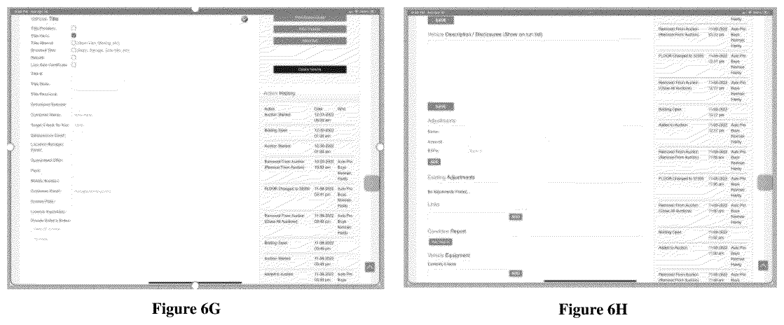

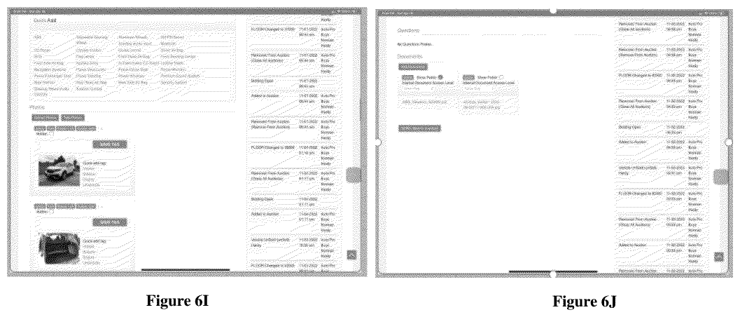

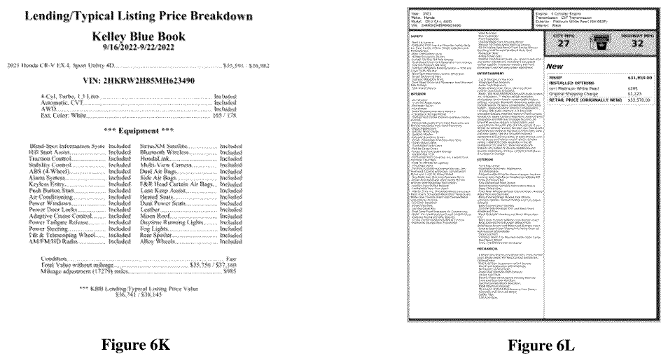

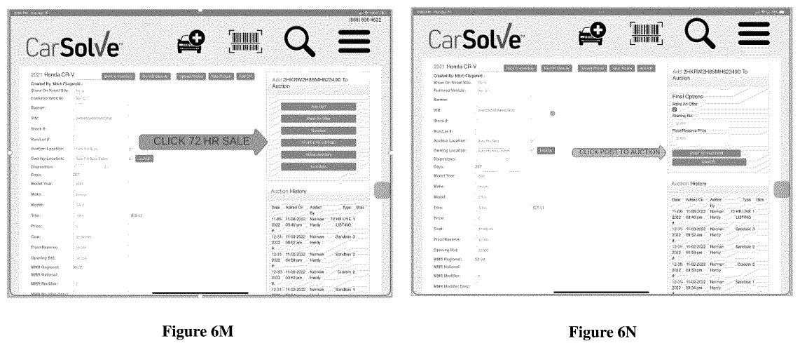

FIGS. 6A-6N show screenshots of sales manager interface 120 for making an offer and for listing the vehicle information in a non-public live online bidding marketplace. In FIG. 6a, an overview of inventory and live bidding events are shown, with options to make an offer and/or start a bidding event. In FIG. 6b, the selling tab is shown. In FIG. 6c, the “not in auction” link is clicked. In FIG. 6d, all vehicles not yet listed in a bidding event are shown. In FIGS. 6e-6j, information for a vehicle selected from the “not in auction” list is shown. In FIG. 6k, the selected vehicle's Kelly Blue Book valuation is shown. In FIG. 6l, the selected vehicle's manufacturer sticker is shown. In FIGS. 6m-6n, the sales manager can start the live bidding event.

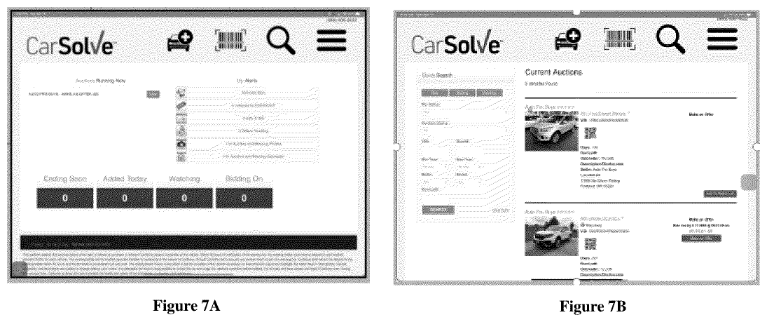

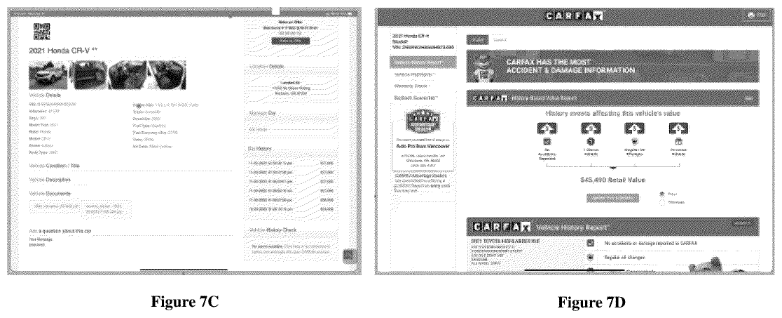

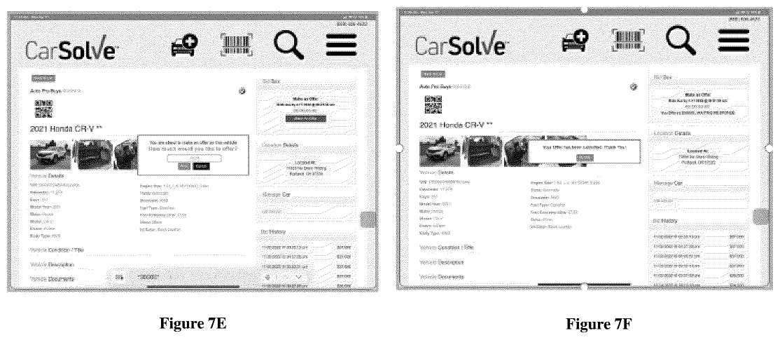

FIGS. 7A-7F show screenshots of buyer interface 150 for shopping for, and bidding on, used vehicles in a non-public live online bidding marketplace.

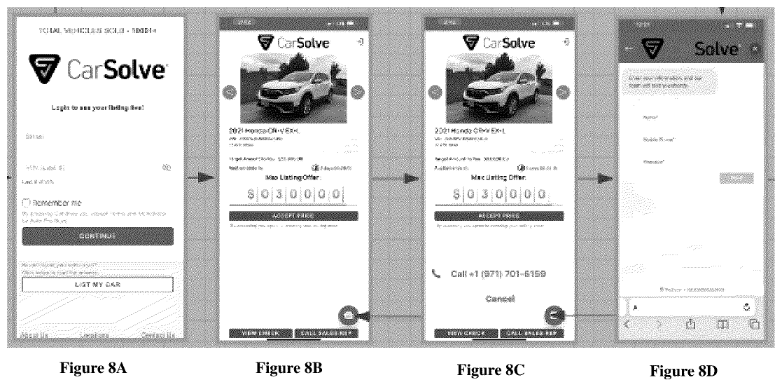

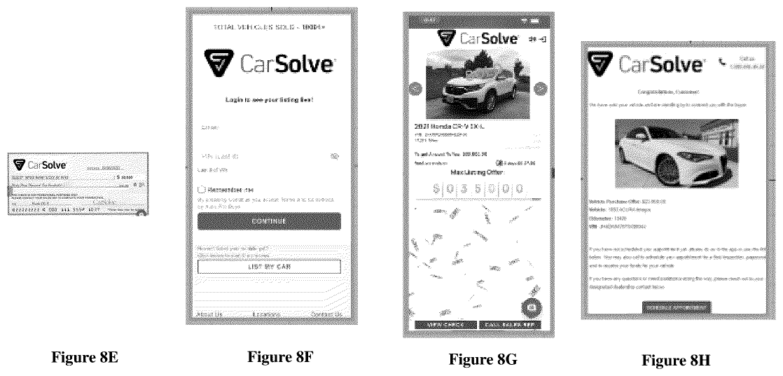

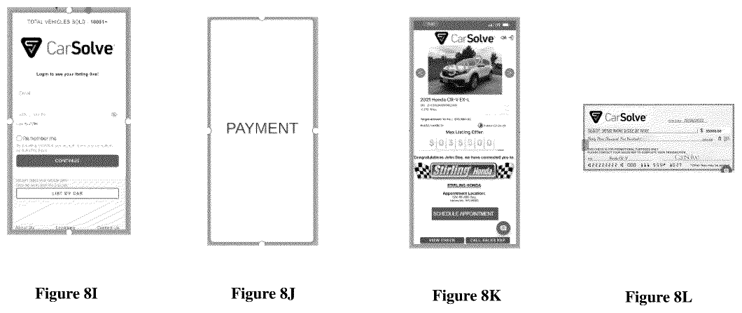

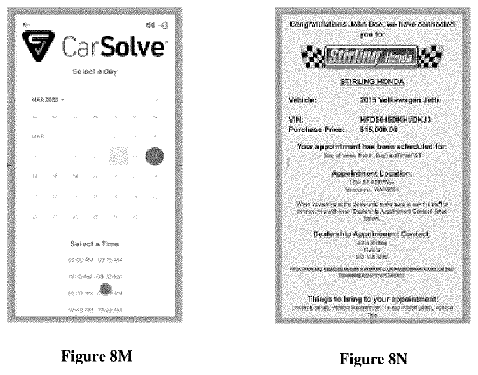

FIGS. 8A-8N show screenshots of seller interface 130 for monitoring a non-public live online bidding marketplace of the seller's used vehicle and for accepting, rejecting, or making a counter offer when the current bid is less than the reserve price.

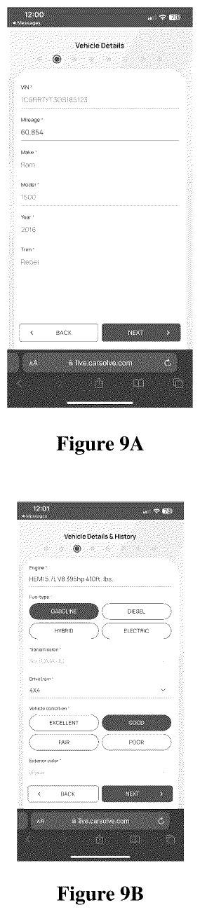

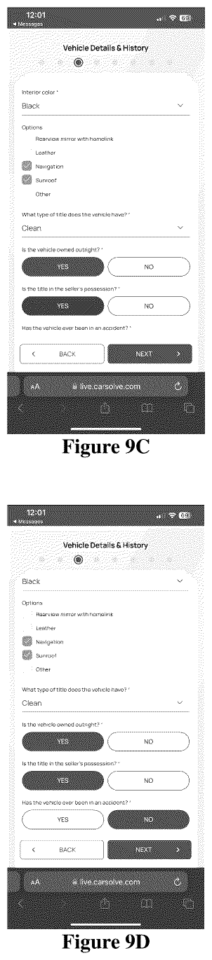

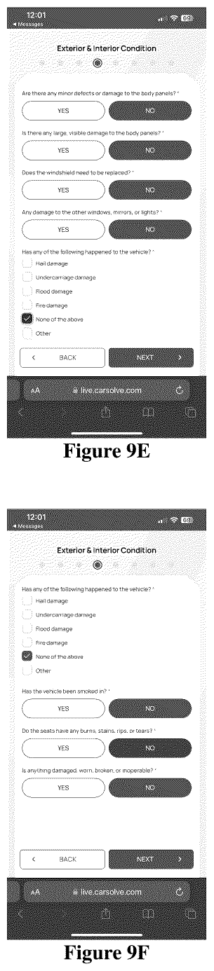

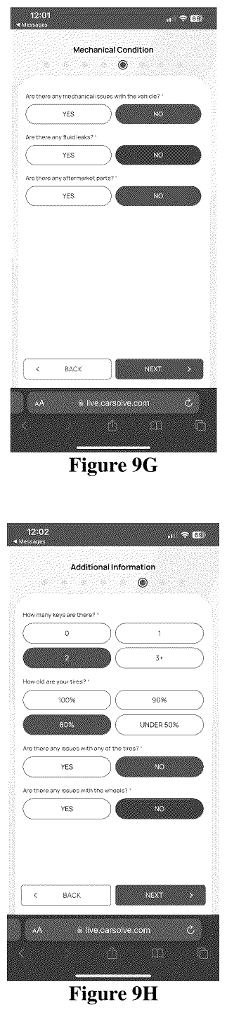

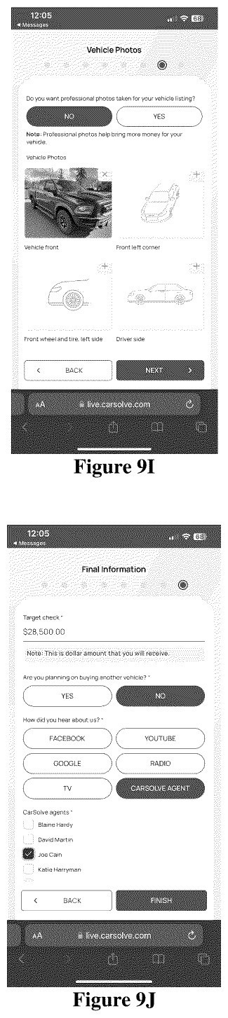

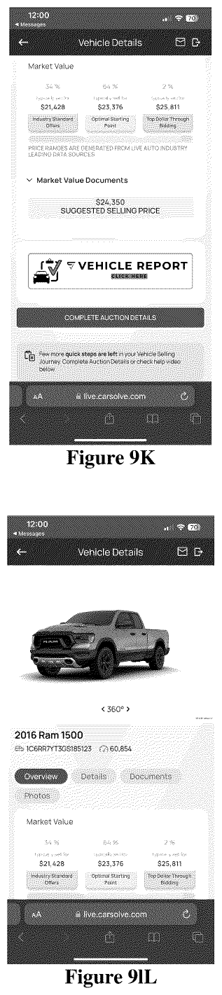

FIGS. 9A-9M show screenshots of a seller interface for registering and listing a used vehicle.

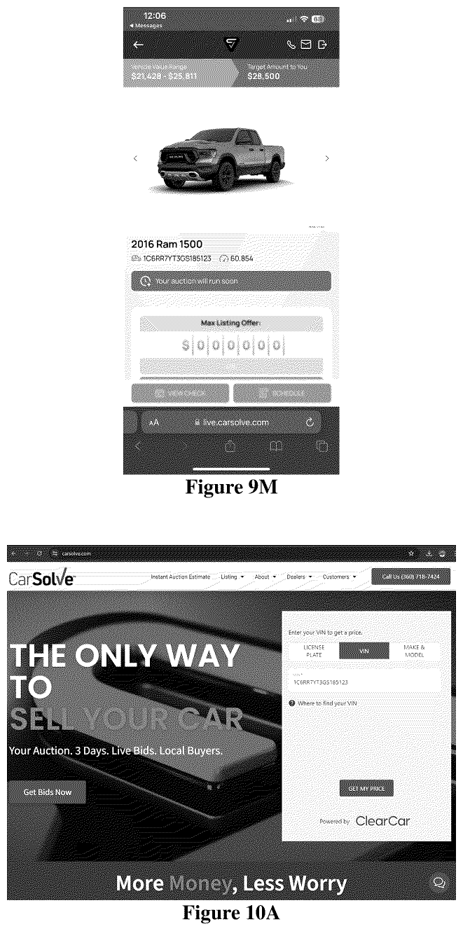

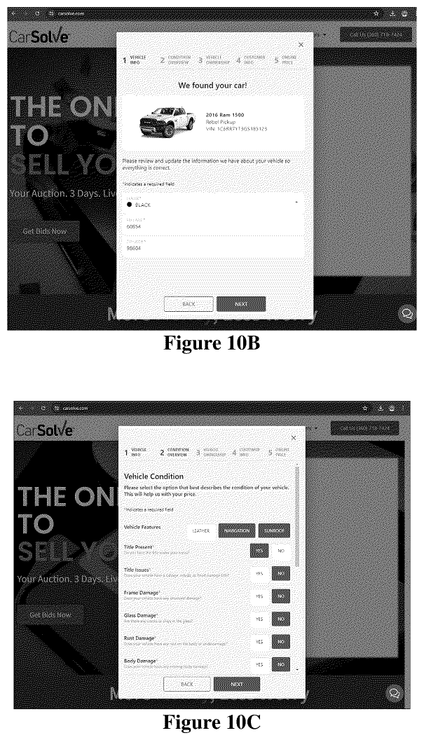

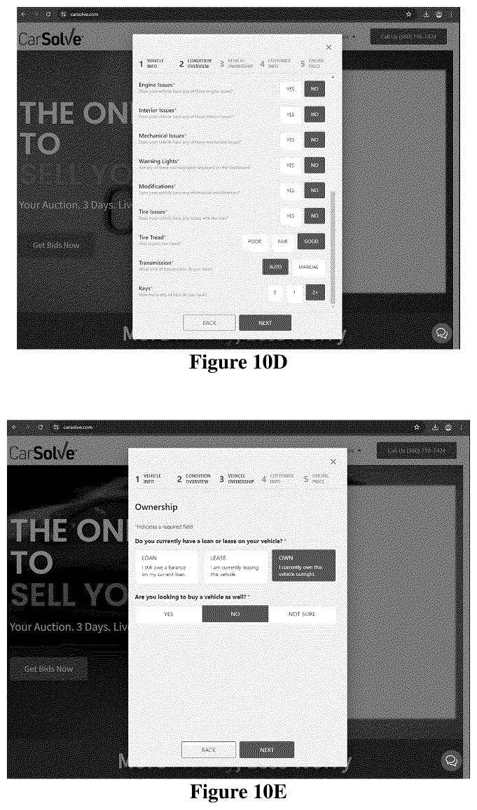

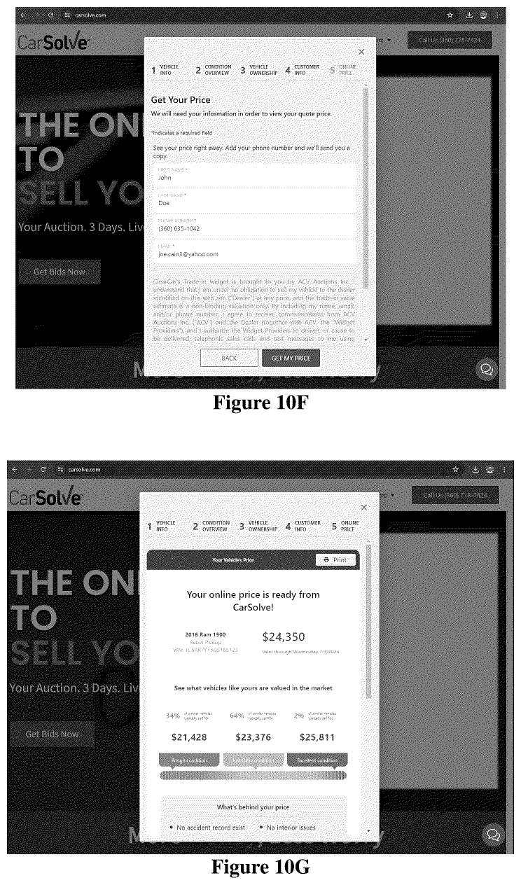

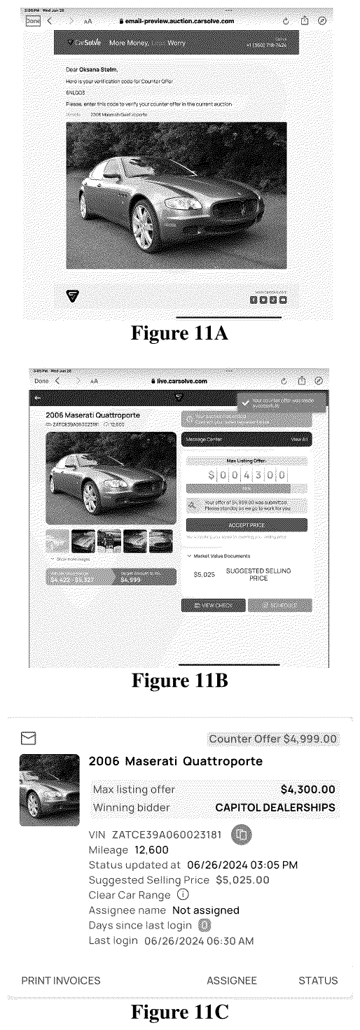

FIGS. 10A-10G show screenshots of a seller interface for reviewing vehicle information and obtaining a valuation.

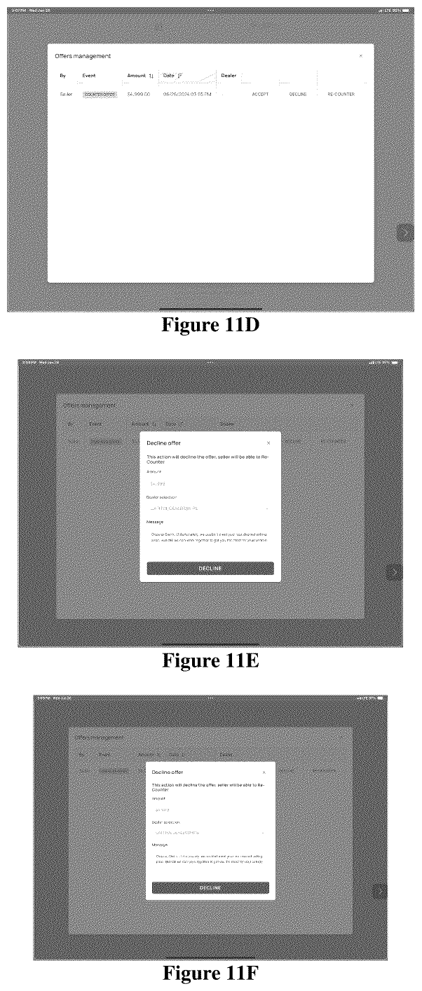

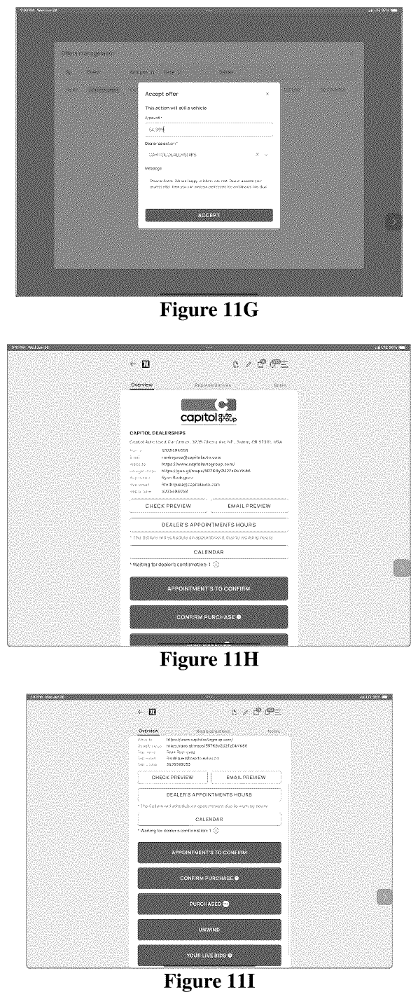

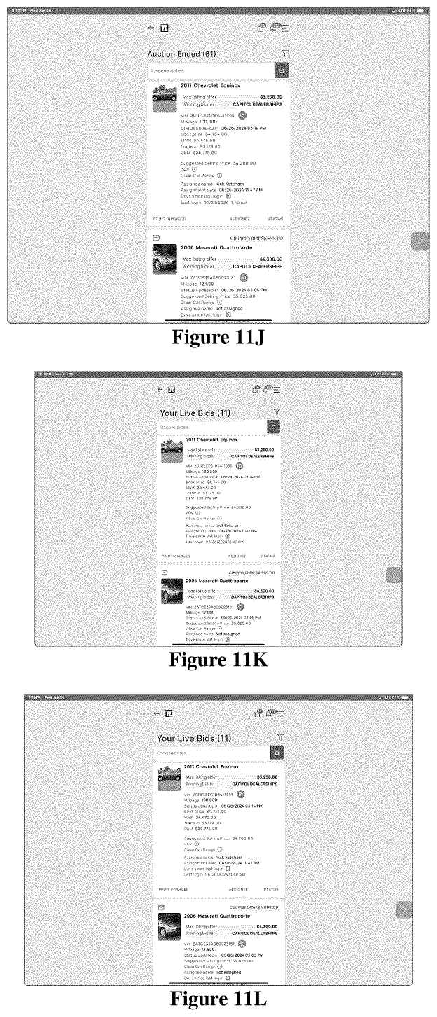

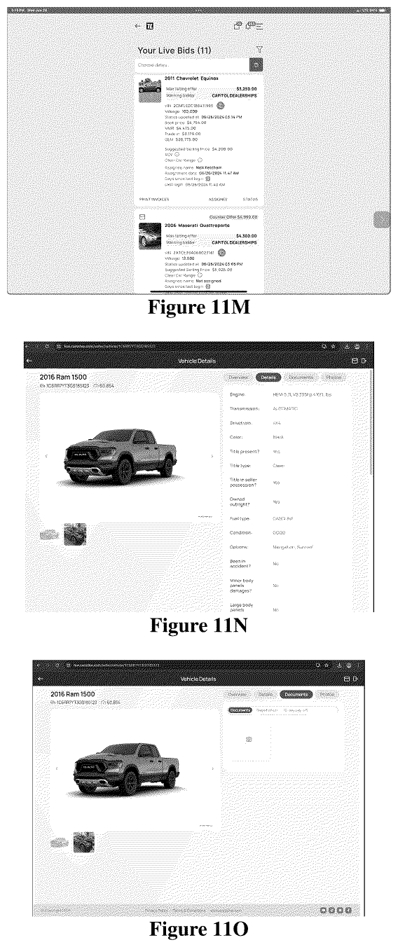

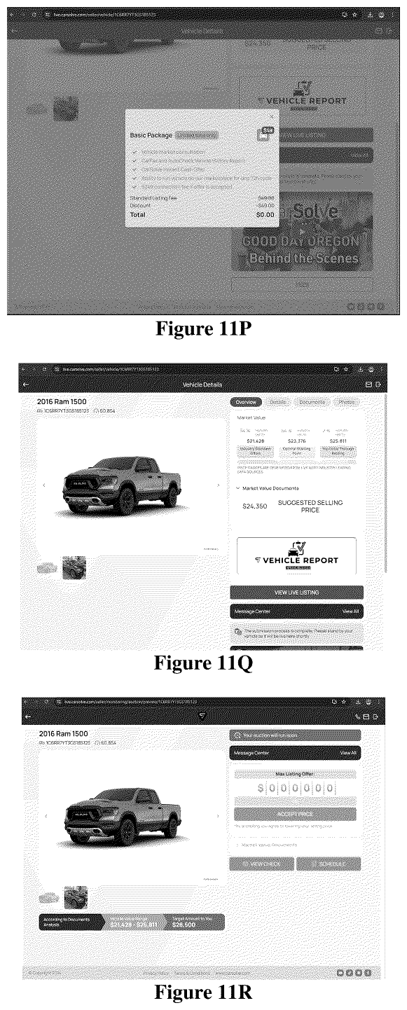

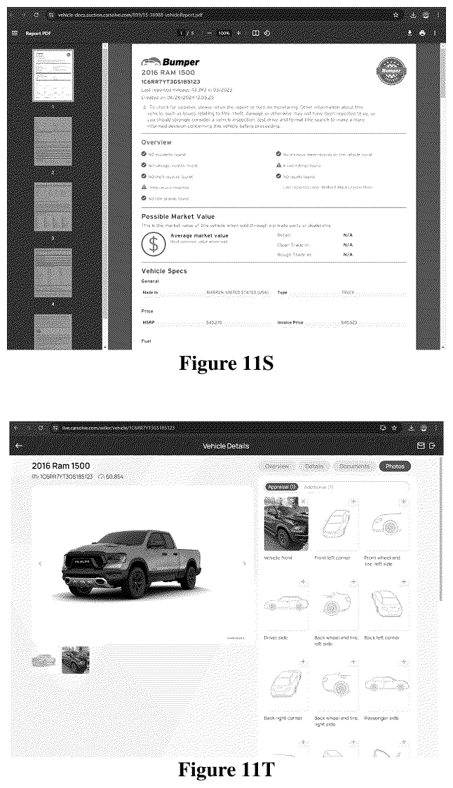

FIGS. 11A-11T show screenshots of a seller interface for monitoring a live online bidding event.

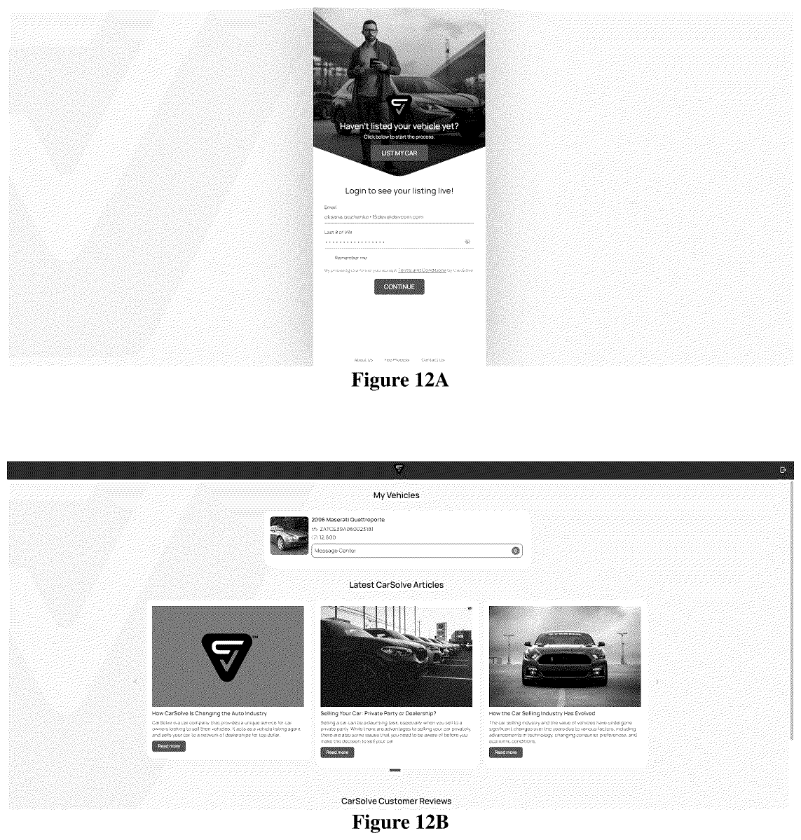

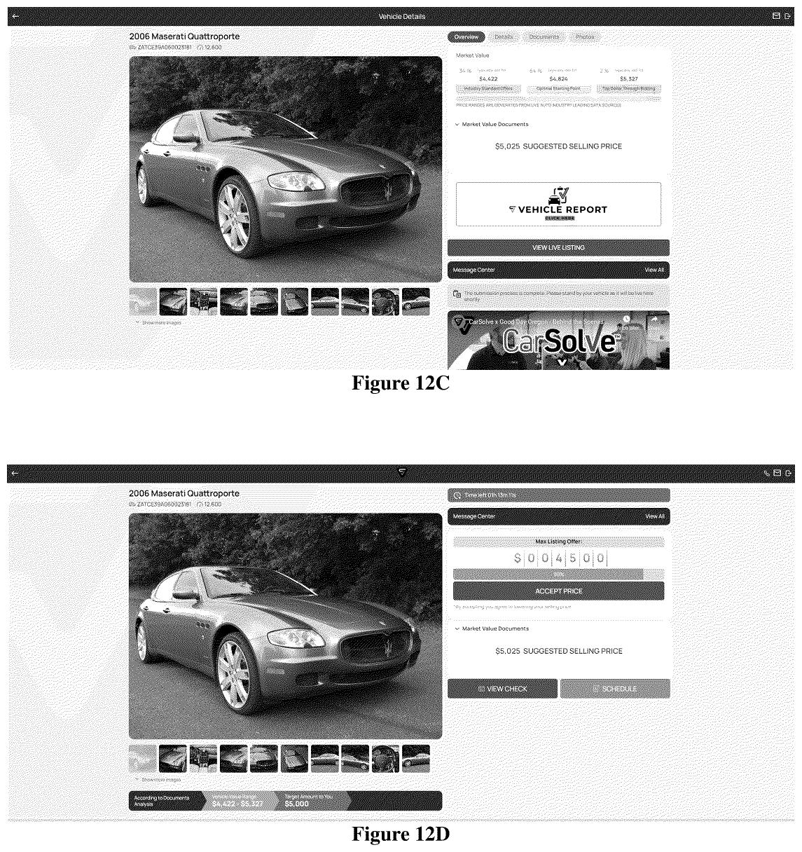

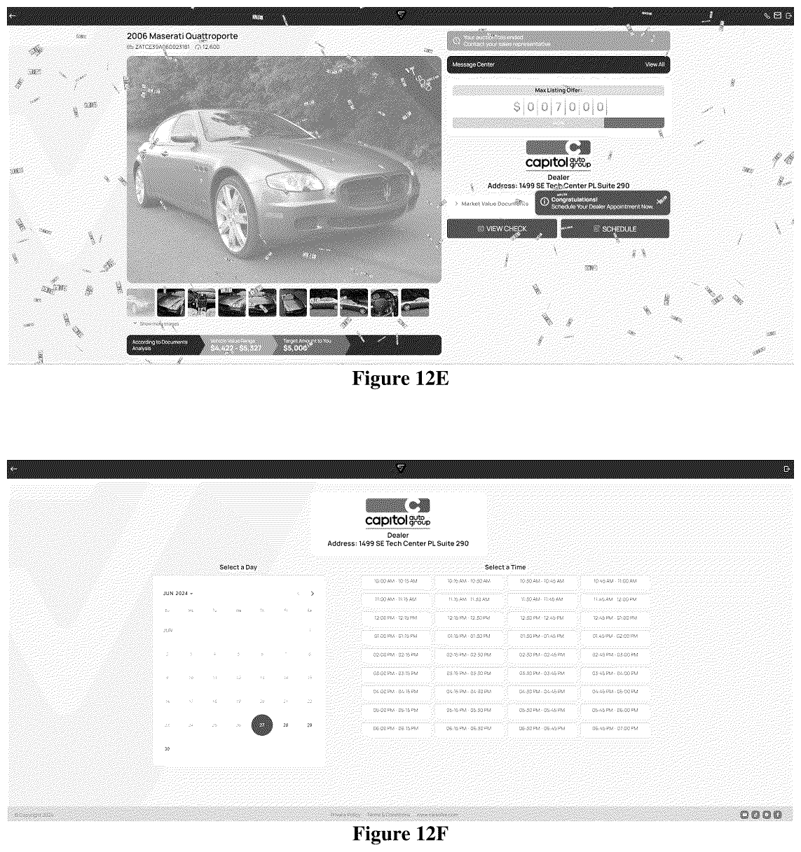

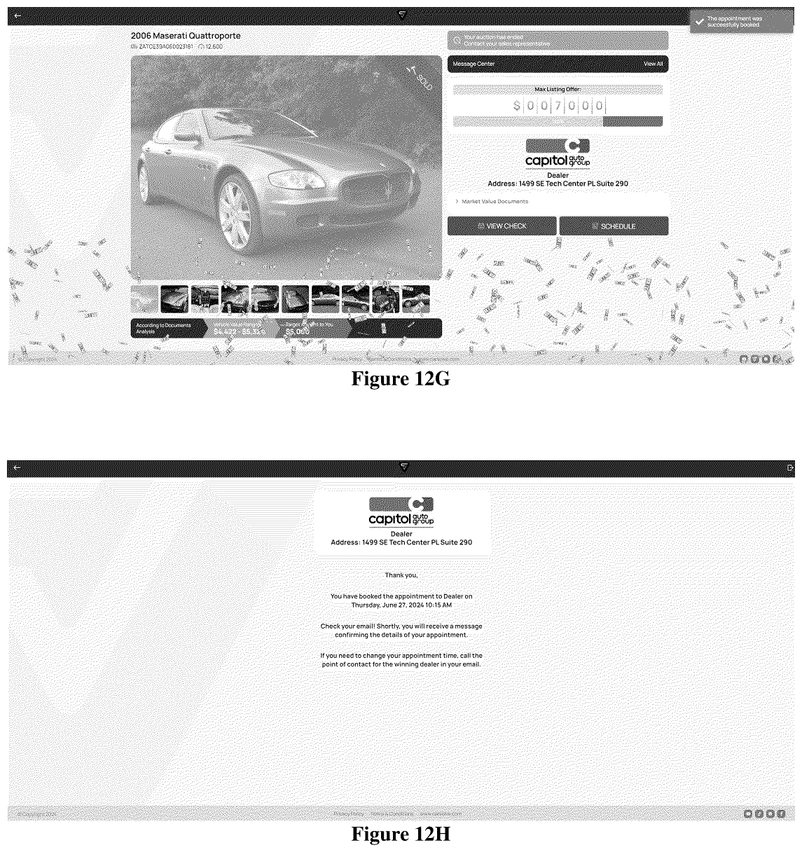

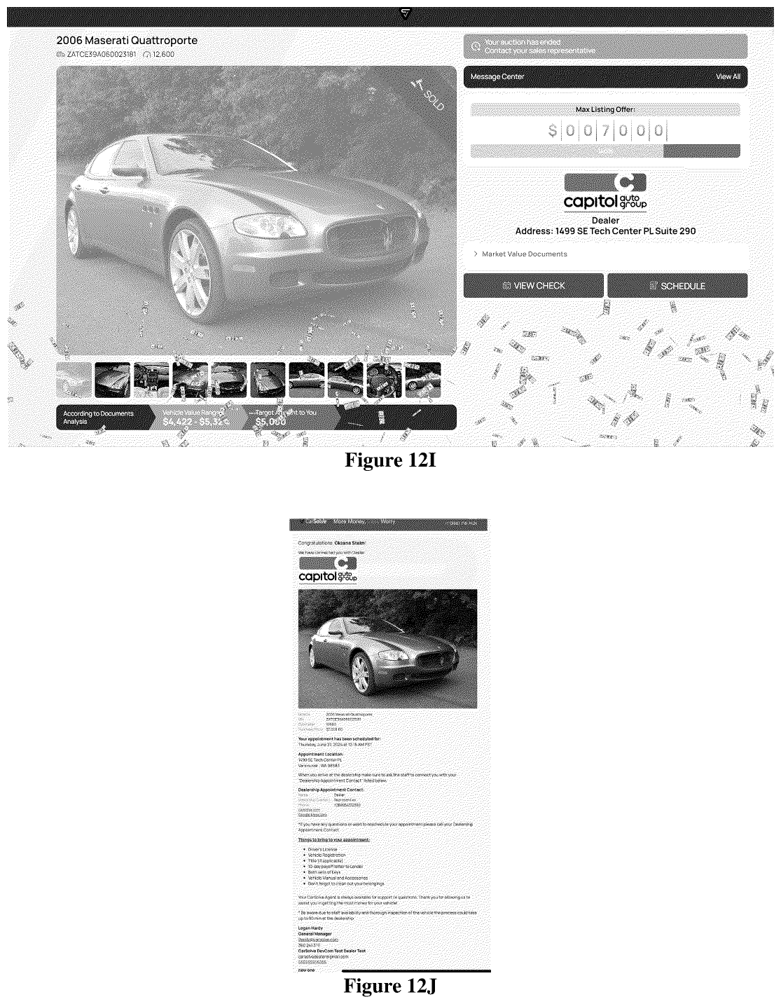

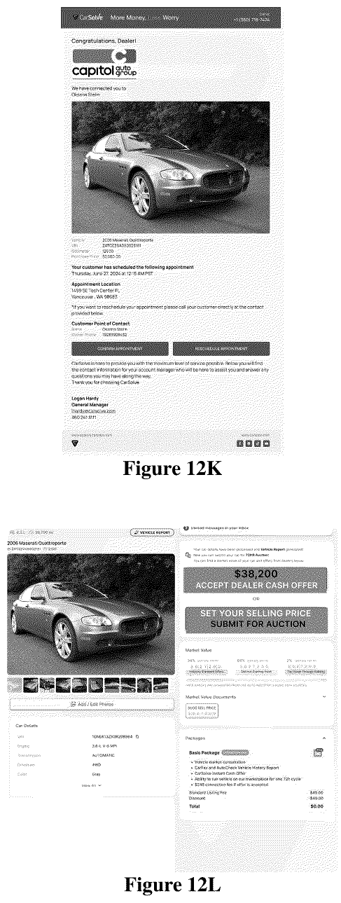

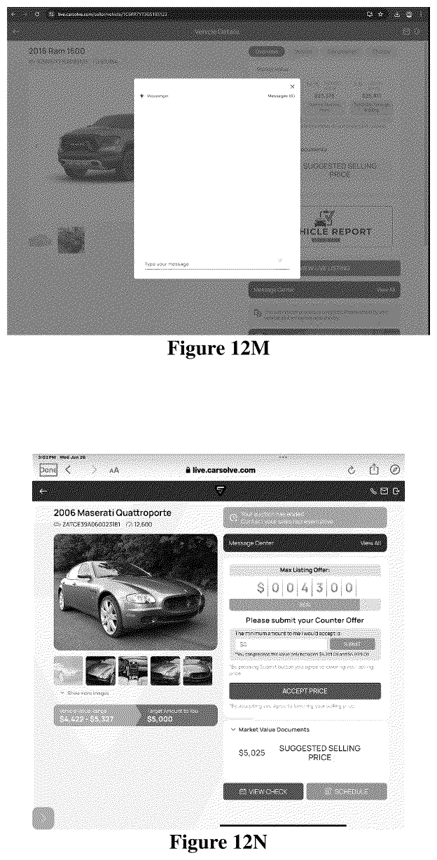

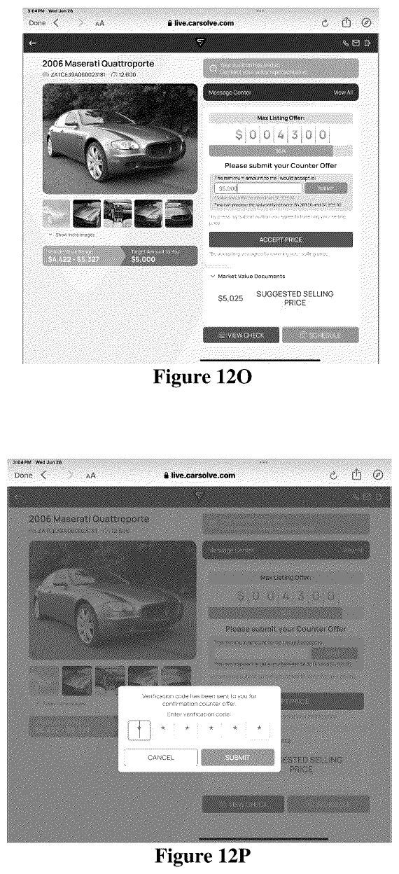

FIGS. 12A-12P show screenshots of a seller interface for monitoring a live online bidding event, making a counter offer, and scheduling an inspection appointment with a winning bidder.

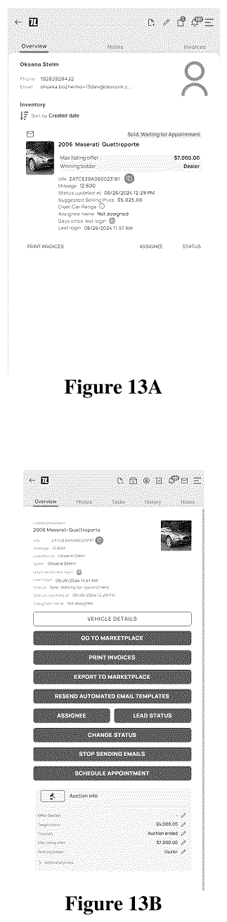

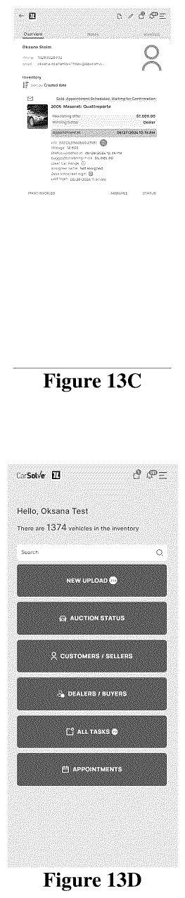

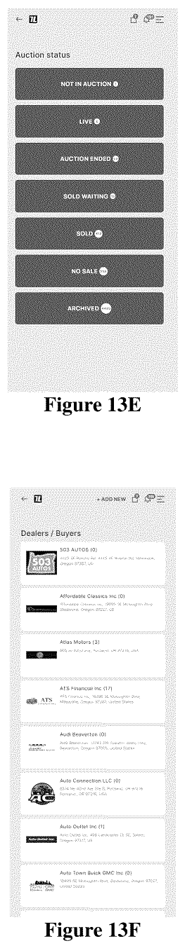

FIGS. 13A-13F show screenshots of a sales manager interface for initiating and monitoring a bidding event.

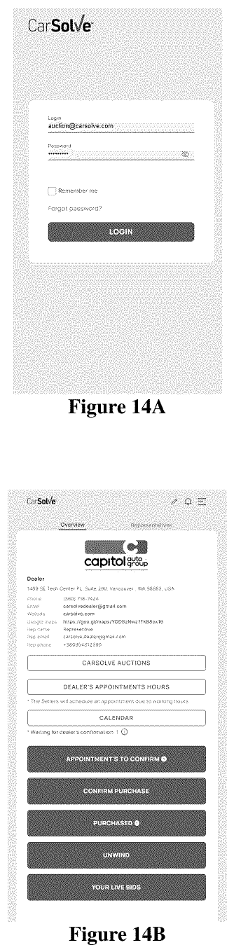

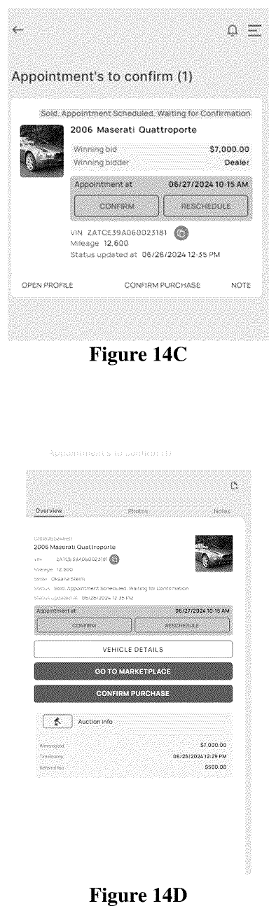

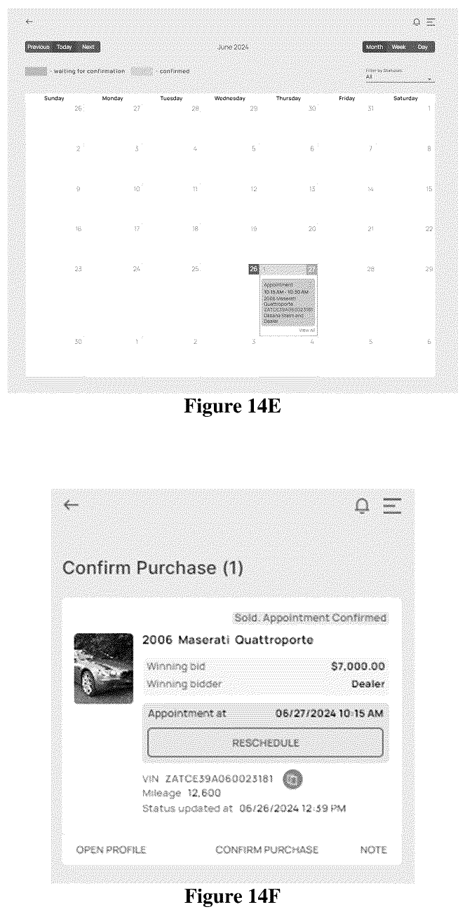

FIGS. 14A-14F show screenshots of a buyer interface for bidding on a vehicle, accepting a counteroffer and scheduling an inspection.

The recitation of ranges of values herein is merely intended to serve as a shorthand method of referring individually to each separate value falling within the range. Unless the context dictates the contrary, all ranges set forth herein should be interpreted as being inclusive of their endpoints, and open-ended ranges should be interpreted to include only commercially practical values. Similarly, all ranges and all lists of values should be considered as inclusive of intermediate values unless the context indicates the contrary.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the inventive subject matter and does not pose a limitation on the scope of the claims unless explicitly stated or context dictates otherwise. No language in the specification should be construed as indicating any non-claimed element essential to the practice of the inventive subject matter.

Groupings of alternative elements or embodiments disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

As used herein, and unless the context dictates otherwise, the term “attached to” and “coupled to” are intended to include both direct coupling (in which two elements that are coupled to each other contact each other) and indirect coupling (in which at least one additional element is located between the two elements). Therefore, the terms “attached to,” “coupled to,” “attached with,” and “coupled with” are used synonymously.

It should be apparent to those skilled in the art that many more modifications besides those already described are possible without departing from the inventive concepts herein. The inventive subject matter, therefore, is not to be restricted except in the spirit of the amended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification refers to at least one of something selected from the group consisting of A, B, C . . . and N, the text should be interpreted as requiring only one element from the group, not A plus N, or B plus N, etc.

What is claimed is:

1. An online bidding system for selling and buying used vehicles comprising:
a seller interface programmed to (i) receive vehicle information from one or more non-dealer sellers interested in selling a vehicle and (ii) send the vehicle information to a listing agent;
a business development platform comprising a listing agent interface and a sales manager interface;
wherein the listing agent interface is programmed to receive the vehicle information and appraise the vehicle;
wherein the sales manager interface is programmed to manage a non-public live online bidding marketplace;
a buyer interface programmed to allow one or more qualified dealers to shop for, and anonymously bid on, the vehicle in the non-public live online bidding marketplace; and
wherein the seller interface is further programmed to monitor the non-public live online bidding marketplace of the vehicle, display a highest bid of the live online bidding marketplace from an anonymous bidder, and display an option to accept, reject, or make a counter offer to, the highest bid when it is lower than a target price;
wherein the sales manager interface is further programmed to display an identity of a winning bidder to the seller upon acceptance of a sale price; and
wherein the sales manager interface has a scheduling module programmed to display to the seller available times for scheduling an inspection of the vehicle with the winning bidder.

2. The bidding system of claim 1, wherein acceptance of a sale price occurs when the highest bid meets or surpasses the target price.

3. The bidding system of claim 1, wherein acceptance of a sale price occurs when the seller and buyer accept a sale price that is lower than the target price.

4. The bidding system of claim 1, wherein the scheduling model is programmed to display on the seller interface a live calendar showing availability of the winning bidder for conducting an inspection of the vehicle.

5. The bidding system of claim 1, wherein the scheduling model is programmed to notify the winning bidder of the seller's requested time for an inspection and to display an option to either accept or reject the requested time.

6. The bidding system of claim 1, wherein the scheduling model is programmed to display on the buyer interface a live calendar with an option to block out unavailable times.

7. The bidding system of claim 1, wherein the buyer interface is programmed to anonymously display competing bids for the vehicle.

8. The bidding system of claim 1, wherein the one or more qualified dealers is a state-licensed dealer that is bonded and insured.

9. The bidding system of claim 1, wherein the one or more qualified dealers is vetted by the listing agent.

10. The bidding system of claim 1, wherein the sales manager interface is further programmed to display an identity of the winning bidder to the seller after the buyer and seller agree on a sale price and after the seller pays a listing fee.

11. The bidding system of claim 1, wherein the listing agent interface is programmed to notify a listing agent when (i) a target price is not met before completion of the live action and (ii) the seller makes a counteroffer.

12. The bidding system of claim 1, wherein the listing agent interface is programmed to allow the listing agent or sales agent to communicate with the seller and the highest bidder to facilitate an anonymous negotiation of a sale price between the seller and the highest bidder.

13. The bidding system of claim 1, wherein the buyer interface includes a rating module programmed to allow the buyer to rate a transaction, a listing agent, or a sales agent.

14. The bidding system of claim 1, wherein the one or more non-dealer sellers are private party sellers only.

15. The bidding system of claim 1, wherein the seller interface is further programmed to provide the seller access to a third-party valuation, third-party history report, and a third-party inspection report.

16. The bidding system of claim 1, wherein the listing agent interface includes a scheduling module programmed to facilitate a consultation between the seller and the listing agent.

17. The bidding system of claim 1, wherein the listing agent interface includes an AI module programmed to interact with the seller to gather the vehicle information.

18. The bidding system of claim 1, wherein the seller interface includes an AI module programmed to consult with the seller regarding a target price of the vehicle.

19. The bidding system of claim 1, wherein the listing agent interface includes a notification module programmed to notify the seller when the vehicle is listed in the non-public live online bidding marketplace and when a bid meeting the target price is placed.
The bidding system of claim 8, wherein the notification module is further programmed to notify the one or more qualified dealers when the vehicle is listed in the non-public live online bidding marketplace.

20. The bidding system of claim 1, wherein the listing agent interface includes an appraisal module programmed to determine a value of the vehicle based on the vehicle information and a third-party valuation database.

21. The bidding system of claim 1, wherein the listing agent interface includes a payment module programmed to process a listing fee from the seller.

22. The bidding system of claim 1, wherein the seller interface includes a listing module programmed to prompt the seller for a target price.

23. The bidding system of claim 1, wherein the seller interface includes a camera module functionally coupled with a camera and programmed to capture one or more images of the vehicle.

24. The bidding system of claim 23, wherein the one or more images includes an odometer of the used vehicle.

25. The bidding system of claim 1, wherein the seller interface is further programmed to present the seller with an option to purchase professional photography services for an additional price.

26. The bidding system of claim 1, wherein the listing agent interface includes an instant offer module programmed to calculate an instant offer estimate for the vehicle.

27. The bidding system of claim 1, wherein the seller interface includes bidding module programmed to display a current bid and a remaining time for the non-public live online bidding marketplace.

28. The bidding system of claim 1, wherein the sales manager interface includes a bidding management module programmed to display a status of the non-public live online bidding marketplace.

29. The bidding system of claim 1, wherein the buyer interface includes a bidding module programmed to display a status of the non-public live online bidding marketplace and an option to place a bid.

30. The bidding system of claim 1, wherein the seller interface includes a listing module programmed to receive the vehicle information and seller information.

31. The bidding system of claim 1, wherein the vehicle information includes one or more of year, make, model, trim, engine size, odometer value, transmission type, drivetrain type, fuel type, number of doors, body style, exterior color, interior color, vehicle condition, tire condition, interior condition, after-market modifications, physical damage, mechanical defects, non-runner, open recalls, rebuilt, ownership type, number of keys, original owner, target price, target sell date, and contact information.
